(19) United States
(12) Patent Application Publication
(10) Pub. No.: US 2022/0383193 A1
(43) Pub. Date: Dec. 1, 2022

(54) ONTOLOGY MAPPING SYSTEM AND ONTOLOGY MAPPING PROGRAM

(71) Applicant: Nippon Telegraph and Telephone Corporation, Tokyo (JP)

(72) Inventors: Jingyu SUN, Musashino-shi, Tokyo (JP); Susumu TAKEUCHI, Musashino-shi, Tokyo (JP); Ikuo YAMASAKI, Musashino-shi, Tokyo (JP)

(21) Appl. No.: 17/773,192

(22) PCT Filed: Oct. 30, 2019
(86) PCT No.: PCT/JP2019/042549

§ 371 Date: Apr. 29, 2022

(51) Int. Cl. G06N 20/00

(52) U.S. Cl. CPC G06N 20/00

(57) ABSTRACT

An ontology mapping system 1 includes: a generation unit 21 that generates non-link training data 31 identifying non-link pairs other than link pairs, from among pairs each associating a node of a first ontology T1 with a node of a second ontology T2 associated by plural link pairs, each associating a node of a first ontology with a node of a second ontology, which is to be mapped to the node of the first ontology, and merges link training data 11 and the non-link training data 31 to generate training data 32; an estimation unit 25 that estimates an expression vector of each node by using a first neural network 33a and a second neural network 33b that have been trained with reference to the training data 32; and a mapping unit 26 that determines, based on a degree of difference between expression vectors of a node of the first ontology and a node of the second ontology, whether or not the nodes are mapped.

### TECHNICAL FIELD

The present invention relates to an ontology mapping system and an ontology mapping program.

### BACKGROUND ART

In plural industries, individually defined data is used. For structuring data used in each industry, cases using ontologies are increasing. However, there are no common rules for designing and creating the ontologies. Therefore, there is a personalized property in ontology that depends on the creator who creates the ontology. In some cases, it is extremely difficult to interpret meaning of data across ontologies, and it may thus be difficult to perform mapping between nodes.

In addition, the vocabulary or structure used in each ontology is different. Therefore, in some cases, it is difficult to find a corresponding node from each ontology.

There are some methods to calculate the degree of similarity between each node of each ontology and determine mapping of each node of each ontology (refer to Non-Patent Literature 1 and Non-Patent Literature 2).

The degree of similarity between each node is calculated by integrating the degree of similarity in vocabulary and the degree of similarity in structure calculated between each node in each ontology.

There are also other methods to input ontology information into the neural network and have the neural network learn the characteristics related to the degree of similarity among nodes (refer to Non-Patent Literature 3 and Non-Patent Literature 4). In these methods, a two-or three-layered, and Full Connected network is generally utilized.

### CITATION LIST

### Non-Patent Literature

Non-Patent Literature 1: Chao Shao 1 et al, “RiMOM-IM: A Novel Iterative Framework for Instance Matching”, JOURNAL OF COMPUTER SCIENCE AND TECHNOLOGY 31(1): 185-197 Jan. 2016. DOI 10.1007/s11390-016-1620-z
Non-Patent Literature 2: Kaladevi Ramar et al, “Technical review on ontology mapping techniques”, Asian Journal of Information Technology 15(4), 676-688, 2016
Non-Patent Literature 3: Warith Eddine Djeddi et al, “Ontology alignment using artificial neural network for large-scale ontologies”, International Journal of Metadata Semantics and Ontologies, May 2013
Non-Patent Literature 4: M. Rubiolo, M.L. Caliusco, et al, “Knowledge Discovery through Ontology Matching: An Approach based on an Articial Neural Network Model”, Information Sciences, Vol. 194, pp. 107-119, 2012.

### SUMMARY OF THE INVENTION

### Technical Problem

In the methods of Non-Patent literature 1 to Non-Patent literature 4, if there is a small number of training data pieces linking each node of each ontology, there are some cases in which learning cannot be done effectively.

The present invention has been made in view of the above circumstances, and an object of the present invention is, in mapping each node in plural ontologies, to provide a technique that enables efficient learning even with a small amount of training data.

### Means for Solving the Problem

An ontology mapping system according to an aspect of the present invention includes: a memory that stores link training data identifying plural link pairs, each associating a node of a first ontology with a node of a second ontology that is to be mapped to the node of the first ontology; a generation unit that generates non-link training data identifying a non-link pair other than the link pairs, from among pairs each associating the node of the first ontology with the node of the second ontology associated by the plural link pairs of the link training data, and merges the link training data and the non-link training data to generate training data; a training unit that trains, with reference to the training data, a first neural network generating an expression vector of each node of the first ontology and a second neural network generating an expression vector of each node of the second ontology; an estimation unit that estimates the expression vector of each node of the first ontology by using the trained first neural network, and the expression vector of each node of the second ontology by using the trained second neural network; and a mapping unit that determines whether or not the node of the first ontology and the node of the second ontology are mapped based on a degree of difference between the expression vectors of the node of the first ontology and the node of the second ontology.

Another aspect of the present invention is an ontology mapping program causing a computer to function as the above-described ontology mapping system.

### Effects of the Invention

According to the present invention, in mapping each node in plural ontologies, it is possible to provide a technique that enables efficient learning even with a small amount of training data.

### BRIEF DESCRIPTION OF DRAWINGS

FIG. 1 is a diagram illustrating functional blocks in an ontology mapping system related to an embodiment of the present invention.

FIG. 2 is diagrams illustrating a process in a generation unit.

FIG. 3 is a flowchart showing an example of a process in a training unit.

FIG. 4 is a diagram illustrating an example of neural networks.

FIG. 5 is diagrams illustrating an attribute expression calculation part.

FIG. 6 is a diagram illustrating an example of a scalar calculation part.

FIG. 7 is a diagram illustrating a node expression calculation part.

FIG. 8 is a flowchart showing an example of a process in a mapping unit.

FIG. 9 is a diagram illustrating a hardware configuration of a computer to be used in the ontology mapping system.

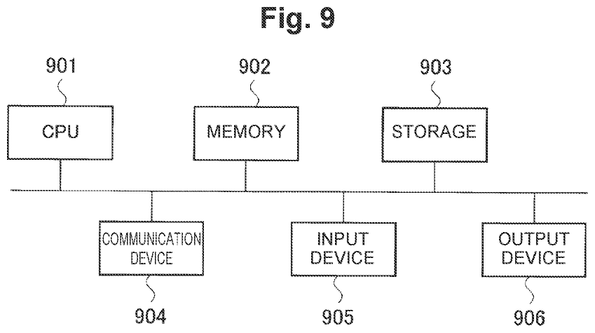

### DESCRIPTION OF EMBODIMENTS

Hereinafter, an embodiment of the present invention will be described with reference to the drawings. In description of the drawings, the same components are assigned with the same reference signs, and explanation thereof will be omitted.

(Configuration of Ontology Mapping System)

In an ontology mapping system related to an embodiment of the present invention, respective nodes of two ontologies are mapped by learning. Each node of the two ontologies is mapped at 1:1.

In the embodiment of the present invention, an ontology mapping system 1 maps a node of a first ontology T1 and a node, which corresponds to the node, of a second ontology T2. The first ontology T1 and the second ontology T2 model domains that are different from each other with a tree structure.

The ontology mapping system 1 is implemented by installing an ontology mapping program that executes predetermined processes on a general computer. The ontology mapping system 1 includes a CPU 901, a memory 902a, and a memory 902b. For the convenience of explanation, the memories 902a and 902b are described as two memories, each of which individually stores data; however, the memories are not limited thereto. Each data used in the ontology mapping system 1 may be stored in one memory or in two or more memories.

The memory 902a and the memory 902a store, as well as the ontology mapping program, link training data 11, first ontology data 12a, second ontology data 12b, non-link training data 31, training data 32, first neural network 33a, second neural network 33b, first expression vector data 34a, second expression vector data 34b, difference degree data 35, and mapping data 36.

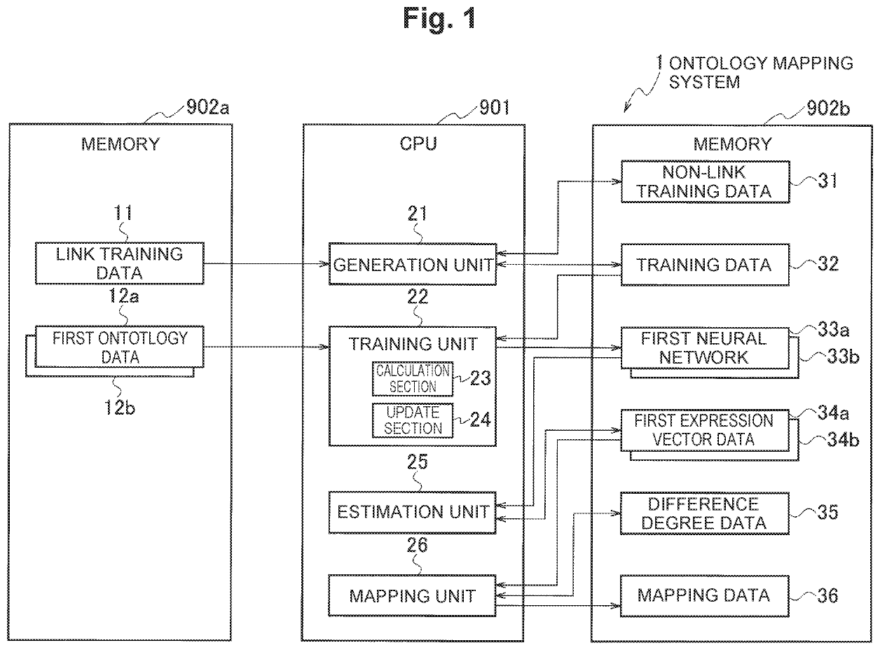

Note that, in the ontology mapping system 1 in the example shown in FIG. 1, only the first ontology data 12a related to the first ontology T1, the first neural network 33a, and the first expression vector data 34a are depicted. However, the ontology mapping system 1 also stores each data related to the second ontology T2.

The link training data 11, the first ontology data 12a, and the second ontology data 12b are stored in advance in the memory when the ontology mapping system 1 starts processing.

The link training data 11 identifies plural link pairs that associate the node of the first ontology T1 with the node of the second ontology T2, which is mapped to the node of the first ontology T1. The link training data 11 is generated by an analyst or the like.

The analyst refers to the first ontology T1 and the second ontology T2, to thereby identify the node of the first ontology T1 and the node of the second ontology T2 having a correlation. The link training data 11 associates each identified node and retains thereof as a link pair of correct links. The link training data 11 retains plural link pairs. The link training data 11 is not required to include all the link pairs but may include a part of the link pairs. Note that the case in which the link training data 11 is generated by the analyst has been described, but generation of the data is not limited thereto.

The first ontology data 12a identifies each node of the first ontology T1. The first ontology data 12a, for example, associates data, such as an identifier of each node constituting the first ontology T1, an attribute of each node, an identifier of a parent node to which each node connects, with one another.

The second ontology data 12b identifies each node of the second ontology T2. The second ontology data 12b has data items similar to those of the first ontology data 12a.

The non-link training data 31, the training data 32, the first neural network 33a, the second neural network 33b, the first expression vector data 34a, the second expression vector data 34b, the difference degree data 35, and the mapping data 36 are generated by processing of the ontology mapping system 1.

The non-link training data 31 is generated by a generation unit 21. The non-link training data 31 identifies plural link pairs that associate the node of the first ontology T1 with the node of the second ontology T2, which is not to be mapped to the node of the first ontology T1.

The training data 32 is generated by the generation unit 21. The training data 32 merges the link training data 11 and the non-link training data 31.

The first neural network 33a is the data generated by a training unit 22 and is the data of the trained neural network. The first neural network 33a is a trained model that has trained for the first ontology T1 with reference to the training data 32.

Similar to the first neural network 33a, the second neural network 33b is the data generated by the training unit 22 and is the data of the trained neural network. The second neural network 33b is a trained model that has trained for the second ontology T2 with reference to the training data 32.

The first expression vector data 34a is generated by an estimation unit 25. The first expression vector data 34a identifies, for each node of the first ontology T1, an expression vector indicating a feature of the node. The expression vector of each node included in the first expression vector data 34a is estimated by referring to the first neural network 33a.

Similar to the first expression vector data 34a, the second expression vector data 34b is generated by the estimation unit 25. The second expression vector data 34b identifies, for each node of the second ontology T2, an expression vector indicating a feature of the node. The expression vector of each node of the second ontology T2 included in the second expression vector data 34b is estimated by referring to the second neural network 33b.

The difference degree data 35 identifies the degree of difference between the node of the first ontology T1 and the node of the second ontology T2. The difference degree data 35 associates, for example, the identifier of the node of the first ontology T1, the identifier of the node of the second ontology T2, and the degree of difference between each expression vector of the two nodes with one another. The degree of difference is, for example, the Euclidean distance.

The mapping data 36 is generated by a mapping unit 26. The mapping data 36 identifies plural link pairs that associate the node of the first ontology T1 with the node of the second ontology, which is to be mapped to the node of the first ontology T1.

The CPU 901 includes the generation unit 21, the training unit 22, the estimation unit 25, and the mapping unit 26.

The generation unit 21 generates the non-link training data 31 that identifies non-link pairs other than the link pairs, from among pairs associating the nodes of the first ontology T1 with the nodes of the second ontology T2 associated by the plural link pairs of the link training data 11. The generation unit 21 further merges the link training data 11 and the non-link training data 31, to thereby generate the training data 32.

In the embodiment of the present invention, a single node of the first ontology T1 is mapped to a single node of the second ontology T2, and a single node of the second ontology T2 is mapped to a single node of the first ontology T1. Therefore, the node identified in the training data 32 is not mapped to any other node. The generation unit 21 generates, from each link pair of the link training data 11, plural non-link pairs identifying the nodes that are not mapped. The non-link pairs are the results of exclusion of the link pairs of the training data 32 from among pairs associating an arbitrary single node of the first ontology T1 with an arbitrary single node of the second ontology T2 provided by each link pair of the training data 32.

Consequently, the generation unit 21 generates the non-link training data 31 from the link training data 11 even with a small number of datasets of the link training data 11. It becomes possible for the generation unit 21 to increase the number of datasets of the training data 32 and improve learning accuracy.

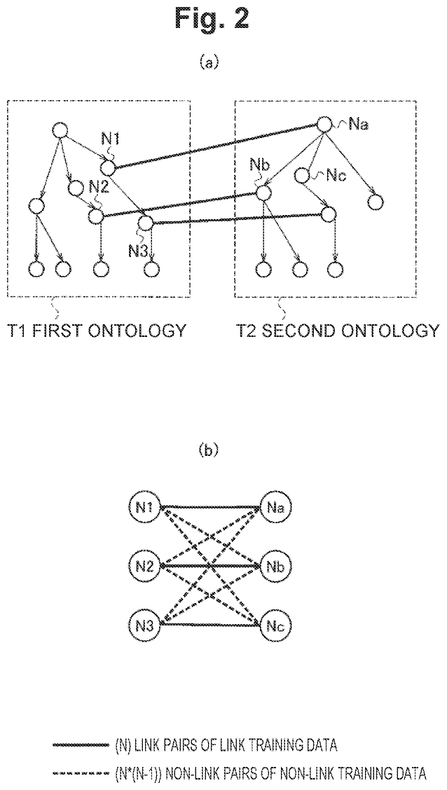

In the example shown in FIG. 2, the node N1 of the first ontology T1 corresponds to the node Na of the second ontology T2, the node N2 of the first ontology T1 corresponds to the node Nb of the second ontology T2, and the node N3 of the first ontology T1 corresponds to the node Nc of the second ontology T2. In the example shown in FIG. 2, the analyst has set three link pairs for the first ontology T1 and the second ontology T2, and the link training data 11 includes three datasets.

Therefore, the generation unit 21 generates non-link pairs other than the link pairs to increase the number of datasets for the training data 32.

Specifically, as shown in FIG. 2(b), the generation unit 21 identifies each of the pair of nodes N1 and Nb and the pair of nodes N1 and Nc as the non-link pair that is not mapped. Similarly, the generation unit 21 identifies each of the pair of nodes N2 and Na, the pair of nodes N2 and Nc, the pair of nodes N3 and Na, and the pair of nodes N3 and Nb as the non-link pair.

Consequently, the generation unit 21 can include six datasets, as well as the three datasets set by the analyst, in the training data 32. The generation unit 21 generates the non-link training data 31 including N*(N−1) non-link pairs in the case where the link training data 11 has N link pairs. This enables the generation unit 21 to generate the training data 32 including N*N datasets. By increasing the number of datasets of the training data 32, it is possible to improve the learning accuracy of the neural network.

With reference to the training data 32, the training unit 22 trains the first neural network 33a, which generates the expression vector of each node of the first ontology T1, and the second neural network 33b, which generates the expression vector of each node of the second ontology T2.

As shown in FIG. 1, the training unit 22 includes a calculation section 23 and an update section 24.

The calculation section 23 calculates the expression vector for each node identified by the training data 32 with reference to a parameter unique to the ontology to which the node belongs. Here, in the first process, the calculation section 23 uses a parameter group that has been arbitrarily set. In the second and subsequent processes, the calculation section 23 uses the parameters set in the latest process in the update section 24. The calculation section 23 uses different parameters in the case of calculating the expression vector of the node in the first ontology T1 and the case of calculating the expression vector of the node in the first ontology T1.

The calculation section 23 sets a first parameter group P1 to be used in the first neural network and calculates the expression vector for each node in the first ontology T1 identified by the training data 32. In addition, the calculation section 23 sets a second parameter group P2 to be used in the second neural network and calculates the expression vector for each node in the second ontology T2 identified by the training data 32.

With reference to the training data 32, and the expression vector of the node in the first ontology T1 and the expression vector of the node in the second ontology T2 that have been calculated by the calculation section 23, the update section 24 updates one or more parameters (a parameter group) so as to minimize a contrastive loss.

The update section 24 calculates, for each pair included in the training data 32, the Euclidean distance between the expression vectors of the respective nodes as the degree of difference between the nodes. The update section 24 calculates the contrastive loss by the following Formula (1) with reference to presence or absence of the link between the nodes defined in the training data 32 and updates each parameter in the first parameter group P1 and the second parameter group P2 to minimize the contrastive loss.

[Math. 1]

L_{Contrastive}=(1−Y)½(D_{w})+(Y)½{max(0,m−D_{w})} Formula (1)
Y: presence or absence of any link of pairs (link is absent: 1, link is present: 0)
m: margin value (normally 10)
D_{w}: Euclidean distance

In the training unit 22, the calculation section 23 repeats the process of calculating the expression vector of each node by using the parameter updated in the update section 24. By use of the parameter last updated by the update section 24, the training unit 22 generates the trained first neural network 33a to be used for the first ontology T1 and the trained second neural network 33b to be used for the second ontology T2.

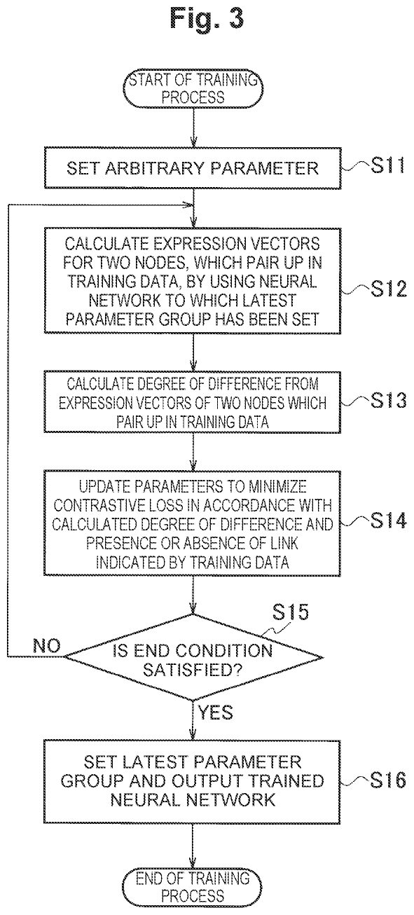

With reference to FIG. 3, a process of the training unit 22 will be described.

First, in step S11, the training unit 22 sets an arbitrary parameter to each parameter in the parameter group for each of the first neural network and the second neural network. In step S12, the calculation section 23 of the training unit 22 calculates the expression vector for each of two nodes forming a pair in the training data 32 by using each neural network to which the latest parameter group has been set.

In step S13, the update section 24 of the training unit 22 calculates the degree of difference from each expression vector calculated in step S12. In step S14, the update section 24 of the training unit 22 updates the parameters of each parameter group to minimize the contrastive loss in accordance with the degree of difference calculated in step S13 and the presence or absence of the link indicated by the training data 32. The parameter group includes parameters used at each layer referenced by the training unit 22. Specifically, the parameter group includes W_{f}, b_{f}, Wᵢ, bᵢ, W_{c}, b_{c}, W_{O}/ b_{O} W, b, W′, b′ to be described later.

In step S15, the training unit 22 determines whether or not a predetermined end condition is satisfied. The end condition is the number of times of processing, the time, the degree of convergence of the parameters, or the like, and is predetermined. If the end condition is not satisfied, the training unit 22 returns the processing to step S12 and calculates the expression vector of each node by using the parameter updated in the latest step S14.

On the other hand, if the end condition is satisfied, the training unit 22 outputs the trained neural network, to which the parameter updated in the latest step S14 has been set, for each ontology. The trained neural network for each ontology output here is the first neural network 33a and the second neural network 33b in FIG. 1.

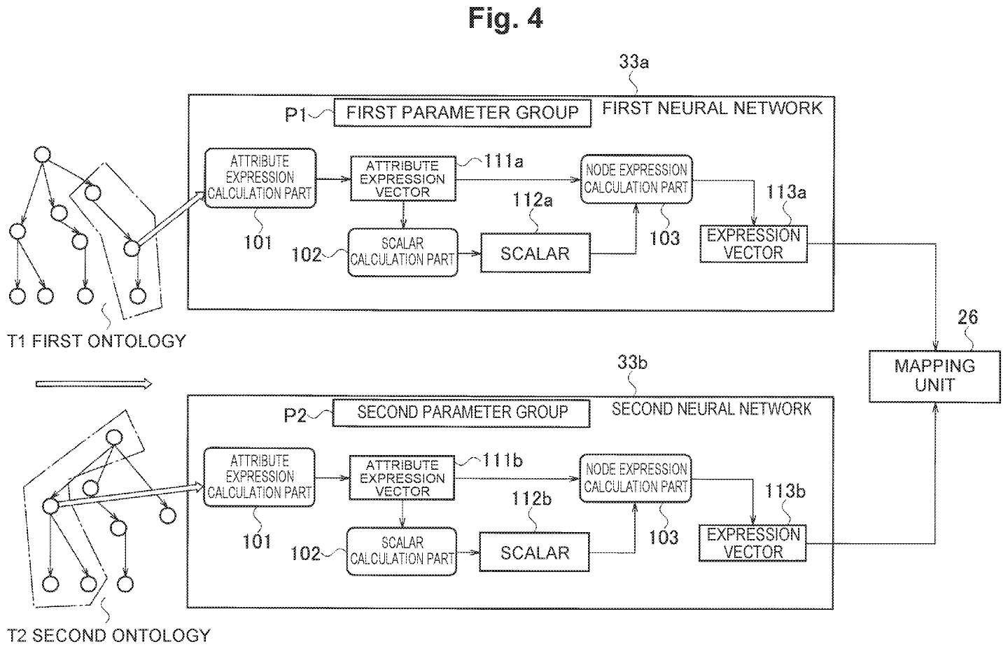

With reference to FIG. 4, the neural network will be described. The first neural network 33a for the first ontology T1 and the second neural network 33b for the second ontology T2 have the similar configurations. However, there is a difference in that the first parameter group P1 is used in the first neural network 33a and the second parameter group P2 is used in the second neural network 33b. Here, the first neural network 33a will be described.

The first neural network 33a includes, as shown in FIG. 4, an attribute expression calculation part 101, a scalar calculation part 102, and a node expression calculation part 103.

For each node identified by the training data 32, the attribute expression calculation part 101 vectorizes the sentence of each attribute with a parameter estimated immediately before, to thereby generate an attribute expression vector 111a. The attribute expression calculation part 101 generates the attribute expression vector 111a by LSTM (Long Shot term Memory). Each attribute includes the attribute of the parent node to which the node connects.

For each node in each ontology, the attribute expression calculation part 101 vectorizes a character string (sentence) of the attribute of the node by using LSTM. In the embodiment of the present invention, each attribute of the node is a name, a label, and a name of the parent. LSTM adds or deletes data by gates such as input, forget, and so on. By using LSTM, calculation of the expression vector can be expected in which a word having a large correlation with the degree of similarity between the nodes is provided with a large weight and a word having a small correlation with the degree of similarity between the nodes is provided with a small weight.

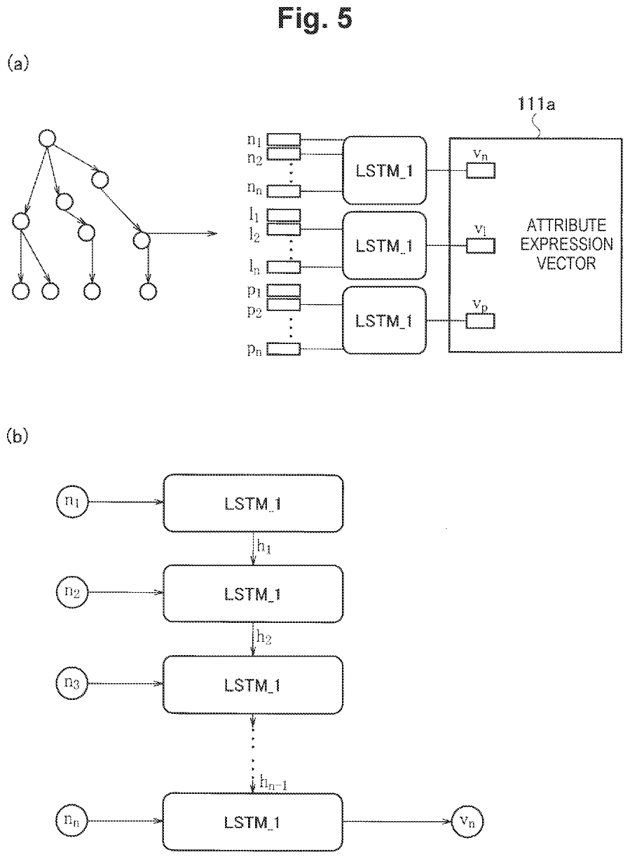

In FIG. 5(a), the attributes related to the name of the node are n₁, n₂, . . . , nₙ, the attributes related to the label are l₁, l₂, . . . , lₙ, and the attributes related to the name of the parent are p₁, P₂, . . . , pₙ. In the embodiment of the present invention, n is formed at 200 and an attribute in one node has 200 sentences. Therefore, each of the attribute expression vectors vₙ, vₗ, and vₚ in one node has 200 dimensions.

Each attribute expression vector of each node is calculated as shown in FIG. 5(b). FIG. 5(b) shows a method of calculating the attribute expression vector vₙ of the name. The attribute expression calculation part 101 inputs one of the 200 sentences related to the name of one node into a module of LSTM_1, and then inputs the output thereof and the next sentence into the module of LSTM_1. The attribute expression calculation part 101 calculates the attribute expression vector vₙ of the name by repeating the process of inputting the output of the process immediately before and the next sentence into the module of LSTM_1. By repeating the process for each attribute, the attribute expression vector 111a of the node is calculated.

The parameter group in the attribute expression calculation part 101 includes W_{f}, b_{f}, Wᵢ , bᵢ , W_{C}, b_{C} , W_{O}, bₒ used in LSTM.

For each node, the scalar calculation part 102 calculates a scalar (attention) 112a for each attribute from the attribute expression vector 111a.

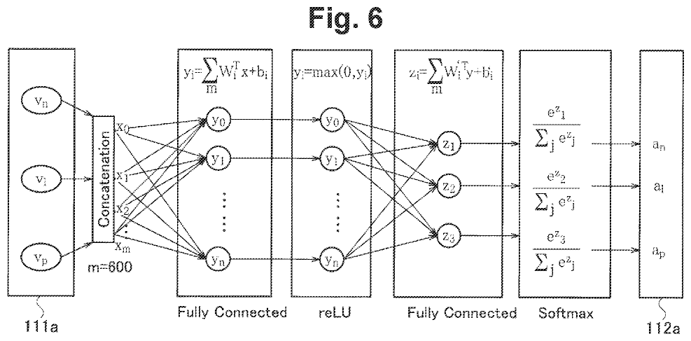

The scalar 112a calculated by the scalar calculation part 102 is the weight of each attribute. In the scalar calculation part 102, as shown in FIG. 6, the scalar aₙ of the name, the scalar aₗ of the label, and the scalar aₚ of the parent's name are calculated via five layers: Concatenation; Fully Connected; reLu; Fully Connected; and Softmax.

The Concatenation layer outputs 200-dimensional*3-attribute vectors from the 200-dimensional*3-attribute vectors. The Fully Connected layer outputs 500-dimensional vectors from the 200-dimensional*3-attribute vectors. The reLu layer outputs 500-dimensional vectors from the 500-dimensional vectors. The Fully Connected layer outputs three-dimensional vectors from the 500-dimensional vectors. The Softmax layer outputs each attribute, specifically, three scalars from the three-dimensional vectors.

The calculating formula in each layer is as shown in FIG. 6. In each calculating formula, i is the identifier of the node in the ontology to be processed. j is the identifier of the attribute of the node in the ontology to be processed. The parameter group in the scalar calculation part 102 includes W, b, W′, b′.

For each node, the node expression calculation part 103 calculates an expression vector by multiplying the attribute expression vector 111a and the scalar 112a of each attribute.

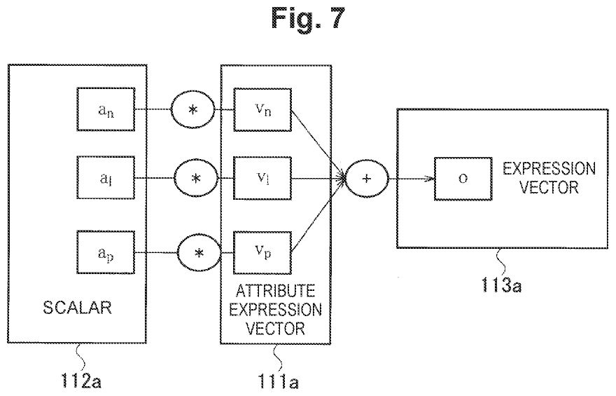

As shown in FIG. 7, for each attribute, the node expression calculation part 103 calculates the expression vector 113a by multiplying the scalar of the attribute to be processed, which is calculated by the scalar calculation part 102, and the attribute expression vector of the attribute to be processed, which is calculated by the attribute expression calculation part 101. This expression vector is expressed by Formula (2).

$$\begin{matrix}[ Math . 2 ] & \\ {o}_{i} = {\sum }_{j = 1}^{N} {a}_{j}^{i} * {v}_{j}^{i} & Formula ( 2 )\end{matrix}$$

Oᵢ :expression vector of node i
N: number of attributes
i: identifier of node
j: identifier of attribute
aⱼⁱ scalar of attribute j of node i
vⱼⁱ: attribute expression vector of attribute j of node i

The expression vector thus calculated is increased or decreased according to the weight of the attribute of the node; therefore, the intent of the link given by the analyst can be reflected in the expression vector.

With the above processing, the training unit 22 trains the first neural network 33a for the first ontology T1. In addition, similar to the first neural network 33a, the training unit 22 also trains the second neural network 33b for the second ontology T2.

The estimation unit 25 estimates the expression vector of each node in the first ontology T1 by using the trained first neural network 33a, and the expression vector of each node in the second ontology T2 by using the trained second neural network 33b. The estimation unit 25 calculates the expression vector for each node in the first ontology T1 and the second ontology T2 by using the first neural network 33a and the second neural network 33b to which the parameter groups have been set.

Based on the degree of difference between the expression vectors of the nodes in the first ontology T1 and the second ontology T2, the mapping unit 26 determines whether or not the nodes in the first ontology T1 and the nodes in the second ontology T2 are mapped. The mapping unit 26 calculates the degree of difference between the nodes from the expression vector of each node calculated by the estimation unit 25 and generates the difference degree data 35. The degree of difference between the nodes is, for example, the Euclidean distance.

The mapping unit 26 determines whether or not the nodes are mapped in accordance with the calculated degree of difference between the nodes. Here, the mapping unit 26 determines to provide a link between nodes in the case where the degree of difference between the nodes is smaller than m set in Formula (1), and not to provide a link between the nodes in the case where the degree of difference is larger than m. The mapping unit 26 associates the presence or absence of the link between the nodes having been determined with the mapping data 36.

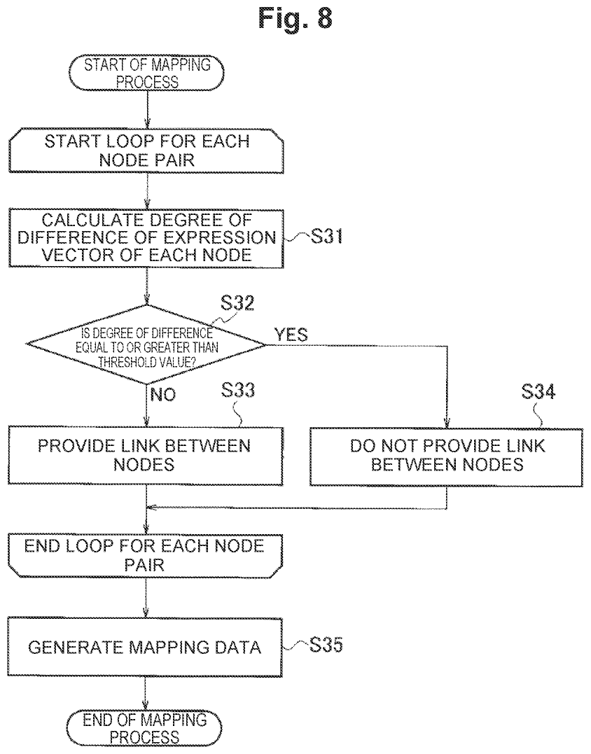

With reference to FIG. 8, the mapping process by the mapping unit 26 will be described.

Step S31 to step S34 are repeated for each combination of the nodes in the first ontology T1 and the nodes in the second ontology T2. Here, combinations of the nodes included in the training data 32 may be excluded from the process.

In step S31, the mapping unit 26 calculates the degree of difference between the expression vectors of the nodes in combination to be processed. In step S32, the mapping unit 26 determines whether or not the degree of difference calculated in step S31 is equal to or greater than a threshold value.

In the case where the degree of difference is not equal to or greater than the threshold value, in step S33, the mapping unit 26 determines to provide a link between the nodes in combination to be processed. In the case where the degree of difference is equal to or greater than the threshold value, in step S34, the mapping unit 26 determines not to provide a link between the nodes in combination to be processed.

After the processes of step S31 to step S34 are performed for each combination to be processed, the mapping process proceeds to step S35. In step S35, the mapping unit 26 generates the mapping data 36 based on the presence or absence of the link between the nodes having been determined in step S33 or step S34. When the mapping data 36 is generated, the mapping unit 26 ends the process.

The ontology mapping system 1 related to the embodiment of the present invention generates the non-link training data 31 from the link training data 11 presented by the analyst, and thereby, it is possible to increase the number of datasets of the training data 32. Consequently, the neural network expressing each ontology can be calculated appropriately.

The neural network also calculates, in addition to the attribute of the node, the degree of importance of each attribute in the node as the scalar. The expression vector calculated by the neural network is output with the value of the expression vector for each attribute weighted by the scalar. Since the attribute deemed to be important, in providing the link, by the analyst can be reflected in the expression vector, the accuracy of the expression vector output by the neural network is improved. This allows the ontology mapping system 1 to determine presence or absence of the link between the nodes other than the training data 32, upon reflecting the intention of the analyst who generated the training data 32.

As the above-described ontology mapping system 1 of the embodiment, for example, a general-purpose computer system including a CPU (Central Processing Unit, a processor) 901, a memory 902, a storage 903 (HDD: hard disk drive, SSD: solid state drive), a communication device 904, an input device 905, and an output device 906 is used. In the computer system, the CPU 901 executes a predetermined program loaded on the memory 902, to thereby implement the functions of the ontology mapping system 1.

Note that the ontology mapping system 1 may be implemented by one computer or by plural computers. Moreover, the ontology mapping system 1 may be a virtual machine that is implemented on a computer.

The program for the ontology mapping system 1 may be stored in a computer-readable recording medium such as an HDD, an SSD, a USB (Universal Serial Bus) memory, a CD (Compact Disc), a DVD (Digital Versatile Disc), or may be distributed via a network.

Note that the present invention is not limited to the above-described embodiment, and various kinds of modifications can be made within the scope of the gist of the present invention.

### REFERENCE SIGNS LIST

1 Ontology mapping system
11 Link training data
12 Ontology data
21 Generation unit
22 Training unit
23 Calculation section
24 Update section
25 Estimation unit
26 Mapping unit
31 Non-link training data
32 Training data
33 Neural network
34 Expression vector data
35 Difference degree data
36 Mapping data
101 Attribute expression calculation part
102 Scalar calculation part
103 Node expression calculation part
111 Attribute expression vector
112 Scalar
113 Expression vector
901 CPU
902 Memory
903 Storage
904 Communication device
905 Input device
906 Output device
P1 First parameter group
P2 Second parameter group
T1 First ontology
T2 Second ontology

1. An ontology mapping system comprising:
a memory that stores link training data identifying a plurality of link pairs, each associating a node of a first ontology with a node of a second ontology that is to be mapped to the node of the first ontology;
a generation unit, implemented using one or more computing devices, that generates non-link training data identifying a non-link pair other than the plurality of link pairs, from among pairs each associating the node of the first ontology with the node of the second ontology associated by the plurality of link pairs of the link training data, and merges the link training data and the non-link training data to generate training data;
a training unit, implemented using one or more computing devices, that trains, with reference to the training data, a first neural network generating an expression vector of each node of the first ontology and a second neural network generating an expression vector of each node of the second ontology;
an estimation unit, implemented using one or more computing devices, that estimates the expression vector of each node of the first ontology by using the trained first neural network, and the expression vector of each node of the second ontology by using the trained second neural network; and
a mapping unit, implemented using one or more computing devices, that determines whether or not the node of the first ontology and the node of the second ontology are mapped based on a degree of difference between the expression vectors of the node of the first ontology and the node of the second ontology.

2. The ontology mapping system according to claim 1,
wherein the training unit comprises:
a calculation section that calculates, with reference to a parameter unique to an ontology to which a node belongs, an expression vector for each node identified by the training data; and
an update section that updates the parameter to minimize a contrastive loss with reference to the training data, an expression vector of the node of the first ontology, and an expression vector of the node of the second ontology,
wherein:
the calculation section repeats a process of calculating an expression vector of each node by using the parameter updated in the update section, and
the trained first neural network to be used for the first ontology and the trained second neural network to be used for the second ontology are generated by using the updated parameter.

3. The ontology mapping system according to claim 2,
wherein the calculation section comprises:
an attribute expression calculation part that vectorizes a sentence of each attribute with a parameter estimated immediately before and generates an attribute expression vector for each node identified by the training data;
a scalar calculation part that calculates a scalar of each attribute from the attribute expression vector for each node; and
a node expression calculation part that calculates an expression vector by multiplying the attribute expression vector and the scalar of each attribute for each node.

4. The ontology mapping system according to claim 3, wherein the attribute expression calculation part generates the attribute expression vector by long shot term memory LSTM).

5. The ontology mapping system according to claim 3, wherein
each attribute includes an attribute of a parent node to which a node connects.

6. A non-transitory recording medium storing an ontology mapping program, wherein execution of the ontology mapping program causes one or more computers of an ontology mapping system to perform operations comprising:
storing link training data identifying a plurality of link pairs, each associating a node of a first ontology with a node of a second ontology that is to be mapped to the node of the first ontology;
generating non-link training data identifying a non-link pair other than the plurality of link pairs, from among pairs each associating the node of the first ontology with the node of the second ontology associated by the plurality of link pairs of the link training data;
merging the link training data and the non-link training data to generate training data;
training, with reference to the training data, a first neural network generating an expression vector of each node of the first ontology and a second neural network generating an expression vector of each node of the second ontology;
estimating the expression vector of each node of the first ontology by using the trained first neural network, and the expression vector of each node of the second ontology by using the trained second neural network; and
determining whether or not the node of the first ontology and the node of the second ontology are mapped based on a degree of difference between the expression vectors of the node of the first ontology and the node of the second ontology.

7. The recording medium according to claim 6,
wherein training the first neural network and the second neural network comprises:
calculating, with reference to a parameter unique to an ontology to which a node belongs, an expression vector for each node identified by the training data; and
updating the parameter to minimize a contrastive loss with reference to the training data, an expression vector of the node of the first ontology, and an expression vector of the node of the second ontology,
wherein:
a process of calculating an expression vector of each node by using the updated parameter is repeated, and
the trained first neural network to be used for the first ontology and the trained second neural network to be used for the second ontology are generated by using the updated parameter.

8. The recording medium according to claim 7,
wherein calculating the expression vector comprises:
vectorizing a sentence of each attribute with a parameter estimated immediately before;
generating an attribute expression vector for each node identified by the training data;
calculating a scalar of each attribute from the attribute expression vector for each node; and
calculating an expression vector by multiplying the attribute expression vector and the scalar of each attribute for each node.

9. The recording medium according to claim 8, wherein the attribute expression vector is generated by long shot term memory (LSTM).

10. The recording medium according to claim 8, wherein each attribute includes an attribute of a parent node to which the a node connects.
